(19) United States
(12) Patent Application Publication
(10) Pub. No.: US 2019/0000262 A1
(43) Pub. Date: Jan. 3, 2019

(54) FILTER MEMBER FOR BREWING COFFEE, APPARATUS AND PRODUCTS COMPRISING SUCH FILTER, METHODS OF MAKING AND USING SUCH FILTER, PRODUCT AND APPARATUS, AND COFFEE BREWING METHODS

(71) Applicant: ROBERT BAO VU, HOUSTON, TX (US)

(72) Inventor: ROBERT BAO VU, HOUSTON, TX (US)

(21) Appl. No.: 15/822,078

(22) Filed: Nov. 24, 2017

Related U.S. Application Data
(60) Provisional application No. 62/425,634, filed on Nov. 23, 2016.

(51) Int. Cl. A47J 31/44; A47J 31/06; A47J 31/40; A47J 31/36; A23F 5/26

(52) U.S. Cl. CPC A47J 31/446; A47J 31/0689; A23F 5/262; A47J 31/369; A47J 31/407

(57) ABSTRACT

A refillable brewing cartridge that includes a fixed metal filter, and a paper filter inserted therein, wherein the paper filter is designed to sorb at least part of any essentially oils or aromatics produced during the brewing process, and retain at least a part of any sediment that is produced during the brewing process.

### RELATED APPLICATION DATA

This application claims priority of U.S. Provisional Patent Application Ser. No. 62/425,634, filed Nov. 23, 2016, which application is herein incorporated by reference.

### BACKGROUND OF THE INVENTION

### 1. Field of the Invention

The present invention relates to apparatus and products for making consumable liquids, and methods of making and using such apparatus, products and liquids. In another aspect, the present invention relates to apparatus and products for brewing such consumable liquids, and methods of making and using such apparatus, products and consumable liquids. In even another aspect, the present invention relates to methods, apparatus and products for brewing consumable liquids and filtering out at least a portion of the oils/sediment produced in the brewing process. In still another aspect, the present invention relates to a sorbent filter insert for use with refillable coffee filters, to refillable coffee filters having a sorbent portion, to brewing systems having a sorbent portion, and to methods of making and using the foregoing. In still another aspect, the present invention relates to a sorbent filter insert for use with refillable single serve coffee filters, to refillable single serve coffee filters having a sorbent portion, to single serve brewing systems having a sorbent portion, and to methods of making and using the foregoing.

### 2. Description of the Related Art

Single cup brewing systems allow for the brewing of a single cup of a brewed beverage such as coffee, tea, or hot chocolate. Generally, a single-serving unit will contain sufficient ground coffee, tea or other beverage material to produce a single cup of the contained beverage. In operation, this single-serving unit is inserted into a machine, with a cup placed under a discharge spout, and within a short period of time, the beverage is ready.

Generally, this type of single serving brewing machine operates by piercing the single serving container with a spray nozzle, while simultaneously piercing the container with a discharge nozzle. The coffee grounds sit on a filter within the container, which filter is not punctured. The spray nozzle introduces water into the container, with the water passing through the grounds and through the filter into the waiting cup.

Currently, the vast majority of cups that will be purchased and utilized in single serve brewing systems are single use cups, which, as are used once in the brewing process and then discarded.

A commercially example of this type of system are the KEURIG™ systems which utilize a disposable “K-Cup” cartridge. For example, see Keurig's U.S. Pat. No. 5,325,765, issued Jul. 5, 1994, and U.S. Pat. No. 5,840,189 issued Nov. 24, 1998, both to Sylvan, et al., which both disclose a beverage filter cartridge that includes an impermeable pierceable base having a predetermined shape and an opening at one end; a self-supporting wettable filter element disposed in the base that sealingly engages with the opening in the base and has a form different and smaller than the predetermined shape of the base so that the filter element diverges from the base and divides the base into two sealed chambers, a first chamber for storing an extract of the beverage to be made, and a second empty chamber for accessing the beverage after the beverage outflow from the filter has been made by combining a liquid with the extract; and an impermeable pierceable cover sealingly engaged with the opening in the base to form an impermeable cartridge.

Other Keurig patents related to such systems include:
U.S. Pat. No. 6,589,577 issued to Lazaris, et al. on Jul. 8, 2003, discloses a disposable single serve beverage filter cartridge that includes an outer container with a bottom, and front, back and side walls extending upwardly from the bottom to a peripheral rim surrounding an upper opening. The side wall is contoured to define interior ledges located above the bottom and extending between the front and back walls. A planar filter element having front, back and side edge regions is configured, dimensioned and positioned to subdivide the interior of the container into first and second chambers, with the front and back edge regions of the filter element secured respectively to the front and back walls of the container, and with side edge regions of the filter element secured to respective interior ledges of the container side walls. A beverage medium is stored in the first chamber. A cover is joined to the container rim to close the upper opening. The cover is yieldably piercable to accommodate an inflow of liquid into the first chamber for combination with the beverage medium to produce a beverage. The filter element is permeable to accommodate passage of the beverage from the first chamber into the second chamber, and the container bottom is yieldably piercable to accommodate an outflow of the beverage from the second chamber to the exterior of the cartridge.
U.S. Pat. No. 6,607,762 issued to Lazaris, et al. on Aug. 19, 2003, discloses a disposable single serve beverage filter cartridge that comprises an outer container with an access opening. A filter element is received in and configured and arranged to subdivide the interior of the container into first and second chambers. A beverage medium is stored in the first chamber. A lid closes the access opening. The lid has a first section overlying the first chamber and a second section overlying the second chamber. The first section of the lid is yieldably piercable to accommodate an inflow of liquid into the first chamber for infusion with the beverage medium to produce a beverage. The filter element is permeable to accommodate a flow of the beverage from the first chamber into the second chamber, and the second section of the lid is yieldably piercable to accommodate an outflow of the beverage from the second chamber to the exterior of the cartridge.
U.S. Pat. No. 6,655,260 issued to Lazaris, et al. on Dec. 2, 2003, discloses a beverage filter cartridge holder. A brewer operates during a brew cycle to brew a beverage by infusing heated liquid with a dry beverage medium contained in a single serve disposable cartridge. During the brew cycle, the cartridge is contained in a cup-shaped housing closed by a lid. Rotation of the cartridge within the housing is resisted by locating surfaces arranged to interengage with at least one surface irregularity in the cartridge sidewall. Inlet and outlet probes pierce the cartridge and serve, respectively, to admit the heated liquid and to remove the served beverage.
U.S. Pat. No. 6,658,989 issued to Sweeney, et al. on Dec. 9, 2003, discloses a re-usable beverage filter cartridge for use in a single serve beverage brewer in which a measured charge of a dry beverage medium is infused with a metered amount of heated liquid to produce a beverage medium. This reusable beverage filter cartridge is provided for containing the beverage medium and for accommodating an inflow of the heated liquid and an outflow of the beverage medium. The cartridge comprises a cup-shaped housing having a top opening and a closed bottom with an outlet port. A filter internally subdivides the housing into a first chamber accessible via the top opening and configured and dimensioned to contain the beverage medium, and a second chamber communicating with the outlet port. A lid is removably secured to the housing in a position closing the top opening, and an inlet port in the lid serves to admit heated liquid into the first chamber for infusion with the beverage medium contained therein. The filter is permeable to accommodate a flow there through of the resulting beverage into the second chamber from which it exits via the outlet port.
U.S. Pat. No. 7,165,488 issued Jan. 23, 2007 and U.S. Pat. No. 7,347,138 Mar. 25, 2008, both to Bragg, disclose a brew chamber for a single serve filter package. The chamber includes a receptacle having an open top, configured and dimensioned to receive the package. A frame supports the receptacle for pivotal movement about a first axis between a vertical brew position and a forwardly inclined open position. A lid is supported on the frame for pivotal movement about a second axis between a raised position allowing access to the open top when the receptacle is in the open position, and a lowered position closing the open top when the receptacle is in the brew position. The receptacle is linked to the lid such that the receptacle is pivoted between the brew and open positions in response to movement of the lid between the lowered and raised positions.
U.S. Pat. No. 7,513,192 issued to Sullivan, et al. on Apr. 7, 2009, discloses a beverage forming system includes an actuator and first and second portions that are movable relative to each other between open and closed positions. The first and second portions include a cartridge receiving portion to accept a cartridge for forming a beverage, e.g., a disposable single serve cartridge. A first linkage member may be fixed to the actuator and physically contact a second linkage member that may be fixed to the first or second portion (or to a frame that supports the first and second portions). Movement of the actuator may cause movement of the first and second linkage members relative to each other, thereby causing relative movement of the first and second portions between open and closed positions.
U.S. Pat. No. 7,523,695 issued to Streeter, et al. on Apr. 28, 2009, discloses a system for dispensing a metered volume of heated water to the brew chamber of a single serve beverage dispenser. The system includes: a storage tank for containing a supply of unheated water, a dispensing tank, and a delivery line communicating with the brew chamber and with the dispensing tank at an intermediate level demarcating the interior of the dispensing tank into upper and lower compartments wherein the volume of the upper compartment is equal to the metered volume. The system also includes a vent valve communicating via a vent line with the upper compartment, and a supply line connecting the storage tank to the lower compartment. An air pump is arranged to deliver pressurized air to the upper compartment. A water pump in the supply line is arranged to deliver water from the storage tank to the lower compartment. A heater for heating water is received in the dispensing tank. Sensing means for generating control signals indicative of the level and temperature of water in the dispensing tank; and a controller enabled by control signals generated by the sensing means and operative in response to a brew signal for operating the air and water pumps in conjunction with the opening and closure of the vent valve to fill the upper compartment with heated water displaced the lower compartment and to discharge the thus displaced heated water from the upper compartment to the brew chamber.
U.S. Pat. No. 8,361,527 issued to Winkler, et al. on Jan. 29, 2013, discloses a method, system and cartridge for forming a beverage includes a cartridge having a container defining an interior space, a lid, a filter, and a beverage medium contained in the interior space. The filter may be attached to the lid only, and extend into the interior space to separate first and second chambers of the cartridge. The filter may hold the beverage medium and be arranged so that, when the lid is removed from the container, e.g., by peeling the lid from the container, the filter and beverage medium are removed together with the lid.

However, the criticism of these single disposable cups is two-fold. First, there is an environmental concern of placing billions of these disposable cups into the waste stream. Second, the cost of buying coffee in these disposable cups is multiples of what such coffee costs in bulk form.

As a result, recent market developments have includes reusable filter cups that are re-filled by the consumer. Thus, the environmental issue is addressed as the reusable nature means there are no cups to place into the waste stream. The cost issue is also addressed, as the consumer will purchase the coffee in bulk and re-fill the reusable cup/pod with this bulk purchased coffee.

One of the earliest and more popular of these refillable filter cartridges includes the SOLOFILL™ cartridge. Embodiments of the popular SOLOFILL™ refillable cartridge can be found in U.S. Patent Application Publication No. 20130017303, published Jan. 17, 2013, by Robert Vu, which discloses apparatus and products for producing beverages and methods for making and using same, including a brewing container for use with brewing machines, the container including a distribution outlet for dispersing the injected water in at least 3 directions away from vertical within the cartridge.

Further embodiments of the popular SOLOFILL™ refillable cartridge can be found in U.S. Pat. No. 9,402,501, issued Aug. 2, 2016 to Vu, which discloses an adjustable tamper coffee apparatus, brewing machine utilizing such apparatus, and methods for making coffee. The coffee brewer includes a brewing chamber, and a brewing cup filled with coffee that is removably received in the brewing chamber. The cup includes a bottom that acts as a tamping member, and this bottom is movable to vary the size of the cup reservoir. Once the cup is positioned in the brewer, the closing of the cup forces engagement of the tamping member and an engagement member positioner in the brewing chamber, resulting in the tamping member being moved to compress the coffee.

It is well known that coffee brewing produces not only the desired coffee, but also essential oils, aromatics and/or sediment that may or may not appear in the produced coffee. Whether or not a consumer desires to have none, part or all of the sediment, essential oils and/or aromatics in the coffee is strictly a personal choice with no right or wrong answer. But, it is clear that the brewing system plays an important part in determining whether such sediment, essential oils and/or aromatics make it into the coffee or not.

Typically, paper filter systems do the most thorough job in removing particulates, and will also sorb some of the essential oils and aromatics from the coffee. For the concerning palate this will yield a brew with less aroma and perceived body. Again, this may or may not be desired by the ultimate consumer.

Other coffee brewing systems employ metal filter elements, however, these reusable metal filters simply are not fine enough to catch everything that is poured into them, meaning they let important elements through the filter and into the cup, such as oils and micro-fines. Further, these metal filters are not sorbant.

Micro-fines are tiny granules of coffee that are small enough to slip through the holes of the filter, which give the cup a darker, cloudy appearance. They also make the flavor of the cup more rich and bold, like coffee brewed in a French press, and settle at the bottom of the cup, leaving a bit of sediment (also like French press coffee).

In the coffee brewing art there are two quite different sorts of perforated metal filters. One sort uses relatively large holes to filter the coffee. They will most if not all of the oils and aromatics through, but will also pass fine particulates into the brewed coffee. These filters are usually integrated into moka pots, Neapolitan flip pots, as well as many percolators. The other kind is the permanent metal filters sold for drip brewers (mainly auto-drip) in which the perforations, in the form of miniscule slits, are much, much finer. Most are either stainless steel or gold-plated in order to prevent off-tastes from being imparted to the coffee. They trap quite a lot of the particulates while passing the oils and aromatics, but the brew won't be quite as “clean” as with paper filters.

A different type of metal filters are the woven wire mesh filters, similar to the material used for window or door screens, but the mesh is considerably finer. Again, no coffee oils or aromatics are sorbed, but a quantity of particulates may be passed through. These filters are typically used with French presses and some auto drip machines.

Plastic filters are sometimes sold with less-expensive drip machines. Like metal filters, plastic filters also do not trap oils and aromatics, and will pass sediment. However, many feel that they impart an undesirable taste to the coffee, and they do not last very long. Nylon mesh filters are also sold for French presses, either for use on their own or in conjunction with the metal mesh filters. These do not seem to cause off-tastes, and will trap more sediment than the mesh filters. Some vacuum pots also use these nylon filters.

Some refillable cartridges have employed a plastic filter element, and various embodiments of the SOLOFILL™ refillable cartridges have employed a metal filter element. This of course means that such refillable cartridges will pass sediment, essential oils and/or aromatics into the brewed coffee.

There have also been refillable cartridges that utilize a paper filter, that are somewhat cumbersome to operate.

Again, it is entirely a personal choice as to whether one desires coffee with or without such essential oils, aromatics and sediment. Additionally, coffee has been recently accused of raising cholesterol, with the accused culprit being the oils that sneak through the metal filters. So, for those consumers wishing to reduce the amount of essential oils, aromatics and/or sediment in their brewed coffee, the problem with such single serve refillable cartridges with plastic or metal filter elements is that they pass oils, aromatics, and/or sediment.

Certainly, a single serve refillable cartridge could be made with a paper filter element incorporated therein, however, the life of such a cartridge would be limited because the paper filter would soon deteriorate, and the prior art cartridges that have utilized a replaceable paper filter have not been as commercially accepted as the permanent filter refillable cartridges with metal filters.

However, in spite of the above advancements the art does not address that need of providing a refillable cartridge with a useful life that also reduces the amount of sediment, essential oils and/or aromatics that pass into the brewed coffee.

Thus, there is a need in the art for a refillable cartridge with a useful life that also reduces the amount of sediment, essential oils and/or aromatics that pass into the brewed coffee.

These and other needs in the art will become apparent to those of skill in the art upon review of this specification, including its drawings and claims.

### SUMMARY OF THE INVENTION

It is an object of the present invention to provide for methods, apparatus and products relating to brewing coffee and other beverages.

It is another object of the present invention to provide for a refillable cartridge with a useful life that also reduces the amount of sediment, essential oils and/or aromatics that pass into the brewed coffee.

These and other objects of the present invention will become apparent to those of skill in the art upon review of this specification, including its drawings and claims.

### SUMMARY OF THE INVENTION

According to one embodiment of the present invention, there is provided a refillable beverage brewing cup. The cup may include a body defining a reservoir configured to receive and support brewing material, defining an opening, and defining a exit port defined within the body and providing a fluid exit path from the reservoir. The cup may also include a fixed filter positioned across the exit port and in the fluid exit path. The cup may also include a removable sorbent filter positioned within the reservoir and abutting the fixed filter.

According to another embodiment of the present invention, there is provided a beverage brewer. This beverage brewer may include a brewing chamber. The beverage brewer may also include a refillable beverage brewing cup, disposed within the brewing chamber. The cup may include a body defining a reservoir configured to receive and support brewing material, defining an opening, and defining a exit port defined within the body and providing a fluid exit path from the reservoir. The cup may also include a fixed filter positioned across the exit port and in the fluid exit path. The cup may also include a removable sorbent filter positioned within the reservoir and abutting the fixed filter.

According to even another embodiment of the present invention, there is provided a method of brewing a beverage with a refillable beverage brewing cup. The cup may include a body defining a reservoir configured to receive and support brewing material, defining an opening, and defining a exit port defined within the body and providing a fluid exit path from the reservoir. The cup may also include a fixed filter positioned across the exit port and in the fluid exit path. The cup may also include a removable sorbent filter positioned within the reservoir and abutting the fixed filter. The method may include introducing heated liquid into the reservoir, which heated liquid forms a beverage after contact with the brewable material. The method may also include flowing the beverage through both the removable sorbent filter and the fixed filter, and out the exit port. The method may also include collecting the beverage thereafter.

Various sub-embodiments of the above embodiments include any one or more of the following: wherein the brewable material is coffee; wherein the removable sorbent filter is elongated and defines openings at each end; wherein the removable sorbent filter comprises paper or cloth; wherein the removable filter comprises paper; and/or wherein the removable sorbent filter is cylindrically shaped and defining openings at each end.

These and other embodiments of the present invention will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a drawing showing an isometric top view, cut away and bottom isometric view of brewing cup 100.

FIG. 2 is a drawing showing sorbent filter element 500.

FIG. 3 is a drawing showing sorbent filter element 500 positioned above brewing cup 100 for insertion into brewing cup 100.

FIG. 4 is a schematic showing sorbent filter element 500 being inserted about half-way into brewing cup 100.

### DETAILED DESCRIPTION OF THE INVENTION

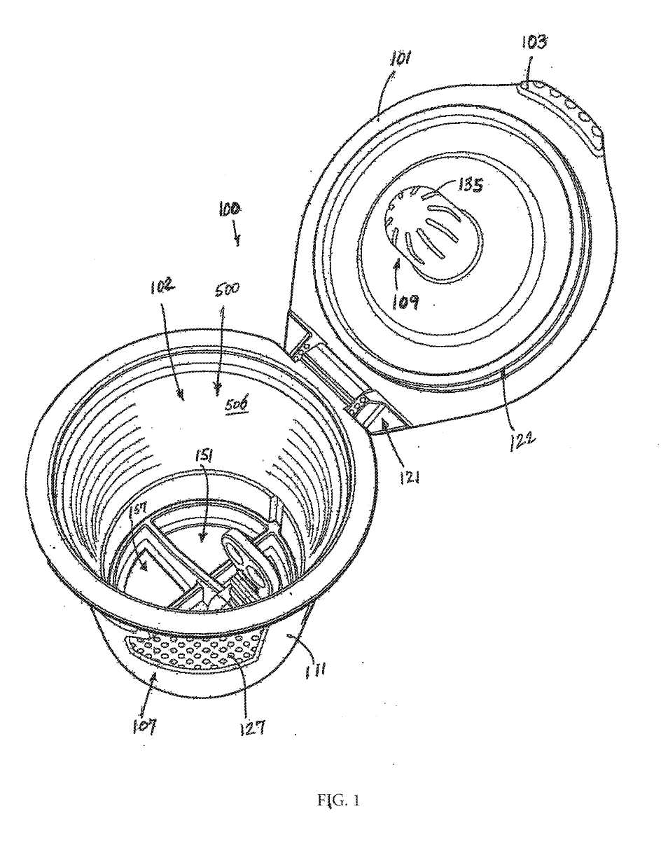

Referring now to FIGS. 1-4 there is shown single serve system 100 of the present invention.

The present invention provides a filter member that is intended for use with a brewing cup, provides a disposable or reusable brewing cup that is intended for use with a brewing machine, provides a brewing machine comprising such a brewing cup, and provides methods of making and using such filter member, cup and machine. Various embodiments of the present invention also provide apparatus that includes the brewing machine having such a brewing cup. Examples of suitable brewing machines include that that are commercially available through Keurig and commonly known as K-Cup machines. A number of brewing machines suitable for use with the brewing cups of the present invention, and which may be suitable in forming the apparatus of the present invention, may be found in many of the patents and publications listed herein, including but not limited to U.S. Pat. No. 5,840,189 and U.S. Pat. No. 5,325,765, both issued to Sylvan.

Various embodiments of the present invention provide a brewing cup that may be utilized in just such machines.

In one aspect, the present invention provides filter members which are intended to be utilized with a refillable brewing cartridge. It should be understood that various filter members with various degrees of sorbency and/or filtering may be provided. For example, filter members with sorbency ranging from very low to very high, and sediment filtering efficiency ranging from low to high.

In the present application, sorbency will generally relate to taking up and holding gases, liquids, and dissolved solids, whereas filtering will generally relate to retaining solids For example, coffee liquids and oils will generally pass through the mesh of a metal or plastic filer, whereas coffee liquids and oils will be sorbed by a paper filter. The degree of sorbency will vary depending upon the type of material utilized. Filtering efficiency is generally related to pore size and shape.

For example, for coffee drinkers desiring less essential oils and/or aromatics but desiring sediment, a filter with higher sorbency and lower sediment filtering efficiency is utilized. As another example, for coffee drinkers desiring less segment but desiring essential oils and/or aromatics, a filter with lower sorbency and higher sediment filtering efficiency is utilized. As even another example, for coffee drinkers wishing to reduce the essential oils, aromatics and sediment, a filter with high sorbency and high sediment filtering efficiency is utilized.

Any suitable material may be utilized for filter member 500 provided that the desired sorbency and sediment filtering is provided. As a non-limiting example, filter member 500 may comprise paper. Paper is known to do a thorough job in removing particulates, and in sorbing some of the essential oils and aromatics from coffee. Certainly, this will yield a brew with less aroma and perceived body. It is also noted that paper filter thicknesses can be easily varied, as can their constituent fibers; as a result, their impact upon the brew's flavor will differ. Paper filters may also be divided into bleached and natural varieties. The natural filters can impart a taste described as wet cardboard, especially if a lower-quality brand is used. Though once bleached with chlorine, most bleached filters are now whitened with oxygen.

As another non-limiting example, filter member 500 may comprise cloth. Cloth filter absorption is similar to that of paper filters, with the advantage that they can be rinsed and re-used many times. They should be very well cleaned periodically, or they may transmit off-flavors to the coffee.

The material selected for Member 500 may be more or less oleophilic, and more or less aquaphilic depending upon the result desired. It may be possible to provide a paper and/or cloth comprising a single that provides the desired properties. Certainly, paper and or cloth may consist of a first fiber that provides the oleophilic property and a second fiber that provides the aquaphilic properties. Such fibers may inherently possess certain oleophilic or aquaphilic property, or may be modified to provide certain properties. In many non-limiting embodiments of the present invention, filter member 500 would have very low aquaphilic properties (perhaps even aquaphobic), and the oleophilic property would depending upon the degree to which one desired to filter out any resulting oils.

In another aspect, the present invention may provide a disposable or reusable brewing cup that is intended for use with a brewing machine. The cup may be designed to provide a single, multiple, or carafe size serving of a consumable liquid. More particularly, the present invention provides either a permanent or removable sorbent filter member that is positioned within the cup and over the plastic or metal filter residing therein.

In another aspect, the present invention may provide an apparatus, i.e., a brewing apparatus or system, which includes a brewing machine into which the disposable or reusable brewing cup is placed. The brewing machine will generally have a brewing chamber into which the cup is positioned.

Non-limiting examples of brewing materials which may be utilized in consumable liquids which may be prepared by the present invention include coffee, tea, cocoa, chocolate, herbs, seeds, berries, nuts, beans, hulls, shells, husks, vegetable matter, leaves, roots, bullion, consume, medicine, vitamins, supplements, and drink powder.

Non-limiting examples of consumable liquids which may be prepared with the methods, apparatus and products of the present invention, include coffee, tea, cocoa, chocolate, herbal drinks, and drinks from berries, seeds, nuts, beans, hulls, shells, husks, vegetable matter, leaves, roots, bullion, consume, medicine, vitamins, supplements, drink powder, and the like.

Non-limiting examples of products of the present invention, include single serving cups loaded with brewing material such as coffee, tea, cocoa, chocolate, herbs, seeds, berries, nuts, beans, hulls, shells, husks, vegetable matter, leaves, roots, bullion, consume, medicine, vitamins, supplements, and drink powder.

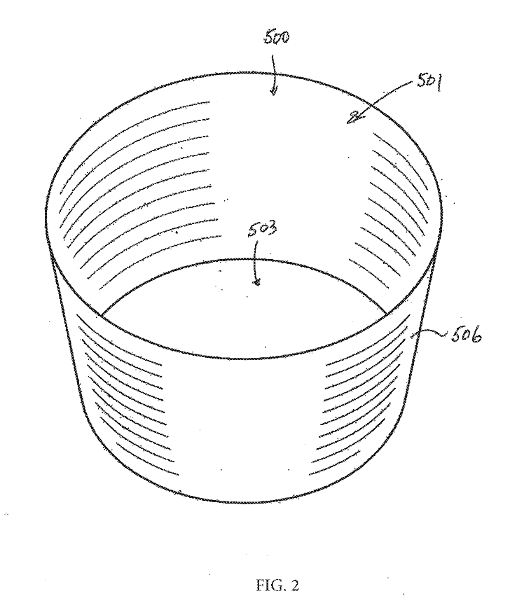

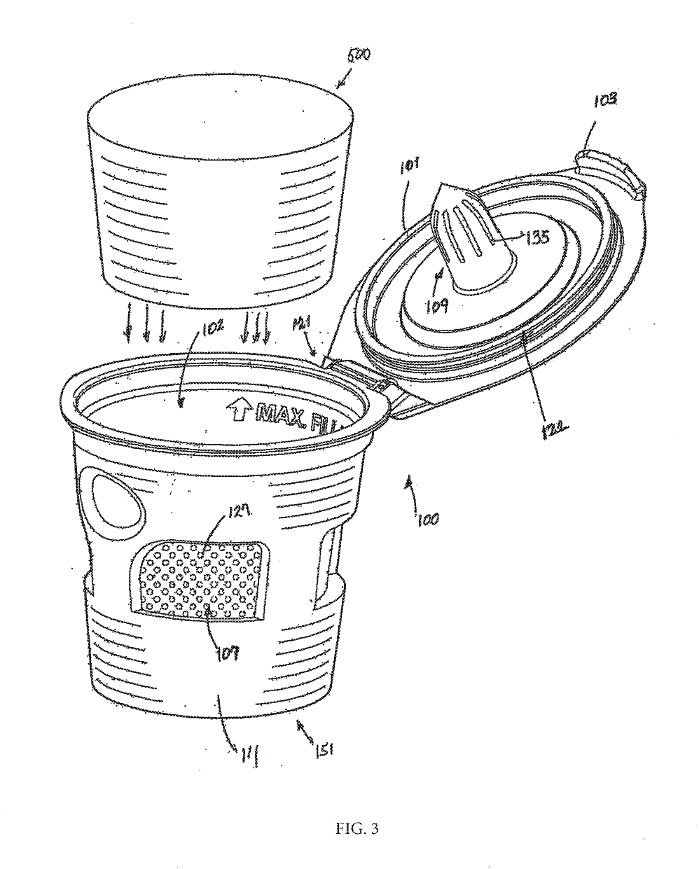

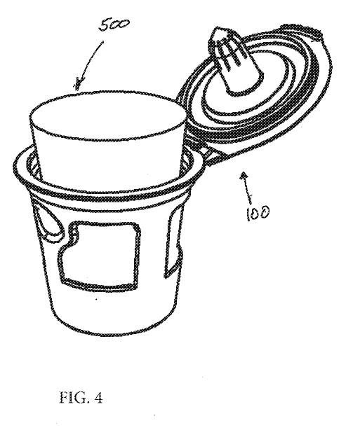

Attention is now directed to FIGS. 1-4 with FIG. 1 being a drawing showing an isometric top view, cut away and bottom isometric view of brewing cup 100, with FIG. 2 being a drawing showing sorbent filter element 500, with FIG. 3 being a drawing showing sorbent filter element 500 positioned above brewing cup 100 for insertion into brewing cup 100. Some non-limiting embodiment envision two or more filter elements 500 nested together and positioned within brewing cartridge 100, and with FIG. 4 being a drawing showing sorbent filter element 500 being inserted about half-way into brewing cup 100.

The present invention is not limited to the exact embodiment of brewing cup 100 as shown. Non-limiting examples of brewing cup 100 include those found in U.S. Patent Application Publication No. 20130017303, U.S. Pat. No. 9,402,501, U.S. Pat. No. 8,720,320, U.S. Pat. No. 9,232,871 and U.S. Pat. No. 9,232,872. It should be understood that the present invention is believed to be useful with about any brewing cup that is now available in the market or that may become available in the market.

Filter member 500 includes a generally cylindrical body 506 which defines top opening 501 and bottom opening 503. The design of filter member 500 is in sharp contrast to traditional filters which have a sealed bottom. One problem with traditional filters is positioning the filter within the brewing cup, especially if there is a complicated mechanism in the bottom of the filter cup, such as with base 151 as shown in FIG. 1. The present filter member 500 with its open bottom 503 is easily positioned within cup 100 without having to navigate the complex base member 151. Further no prior art single serve refillable cartridges utilize both a sorbent filter in combination with a metal filter, or a removable filter member in combination with the integral metal filter.

Brewing cup 100 may be disposable or reusable. While brewing cup 100 is preferably a single serving brew cup, in other embodiments it is envisioned that brewing cup 100 may provide multiple servings or even a carafe sized serving, this will all depend upon the size of reservoir 102 which will hold the brewing material, and of course the ability of the machine to receive cup 100. This brewing cup 100 may include a cup body 111, top 101, and base 151. While not necessary, in the embodiment as shown, at least a portion of base 151 being movable within cup body 111 to provide a tamping effect on the contents of cup body 111 as disclosed in U.S. Pat. No. 9,402,501. Reservoir 102 is defined by the body 111, top 101 and base 151. Top 101 may include an inlet passage (not shown) for receiving a brewing liquid from the brewing machine providing passage to optional distribution nozzle 135. Many brewing machines will include a tubular injector that is inserted into inlet passage 105 and provides brewing liquid to the cup and this injection may function as a distribution nozzle. Cup body 111 may define one or more passages 107, and base 151 may define one or more passages 157, with these passages allowing brewing liquid to exit cup 100. Cup 100 may include passages 107 or passages 157, or both passages 107 and 157. Flow passages 107 are generally covered with filters 127, and flow passages 157 of base member 151 are generally covered with filters (not shown). These filters may be the same or different filter size and generally restrain the brewing material while allowing the brewing liquid to pass through.

Brewing cup 100 may further include grip 103 used for opening top 101, seal 122 for sealing top 101 and cup body 111, distribution nozzle 135 in liquid communication with the inlet passage and having one or more outlets 109, and hinge 121. Distribution nozzle 135 is not necessary, as brewing liquid may be provided directly from the brewing machine tubular injector, and this injector may also be provided with one or more outlet passages. Top 101 generally will friction fit to cup body 111.

In operation, lid 101 is operable to be opened and closed. That is, lid 101 may be operable in an open position to allow refilling of replacement of cup 100, and then operable to reseal cup 100 for brewing. As shown in FIG. 3, with top 101 opened, filter member 500 is inserted into reservoir 102 and into position as shown in FIG. 1.

During brewing and depending upon its properties, filter member 500 may serve to sorb part or all of any essential oils and/or aromatics, and may retain part or all of any sediments.

Once brewing is complete, filter member 500 is generally removed, although depending upon the desires of the particular coffee drinker and the condition of filter member 500, it is possible in some instances to utilize filter member more than once.

Various inventive embodiments of the present invention include the inventive filter member, the inventive refillable cartridge with filter member, a brewing system including the refillable cartridge with filter member, and methods of making and using the foregoing.

The brewing cups of the present invention are very easily utilized in the known commercially available single serve coffee machines that utilize Keurig's K-Cups or similar cups offered by other coffee companies.

Some non-limiting method embodiments of the present invention also include apparatus having a set of 2 or more distinct filter members of various sorbency and sediment filtering efficiency.

Various non-limiting method embodiments of the present invention may include any combination of one or more of insertion of a filter member into a refillable cartridge and into place over the cartridge filter member, removal of a filter member from the refillable cartridge, and/or positioning two or more such filter members into place in the refillable cartridge over the cartridge filter member.

All of the patents, publications, applications, articles, books, magazines, and any other prior art cited in this specification, are herein incorporated by reference.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below. Regarding the independent claims, it should be understood that other independent claims may be pursued and that the present filing is only being limited to the listed independent claims because of filing fee budget reasons, not because the present invention is to be limited to the listed independent claims. Other independent claims may include other apparatus claims, product claims, composition claims, and method claims as supported by this specification.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A refillable beverage brewing cup comprising:
a body defining a reservoir configured to receive and support brewing material, defining an opening, and defining a exit port defined within the body and providing a fluid exit path from the reservoir;
a fixed filter positioned across the exit port and in the fluid exit path; and,
a removable sorbent filter positioned within the reservoir and abutting the fixed filter.

2. The cup of claim 1, wherein the removable sorbent filter is elongated and defines openings at each end.

3. The cup of claim 2, wherein the removable sorbent filter comprises paper or cloth.

4. The cup of claim 2, wherein the removable filter comprises paper, and the fixed filter comprises metal.

5. The cup of claim 1, wherein the removable sorbent filter is cylindrically shaped and defining openings at each end.

6. The cup of claim 5, wherein the removable sorbent filter comprises paper or cloth.

7. The cup of claim 5, wherein the removable filter comprises paper, and the fixed filter comprises metal.

8. A beverage brewer comprising:
A brewing chamber;
A refillable beverage brewing cup, disposed within the brewing chamber, wherein the cup comprises:
a body defining a reservoir configured to receive and support brewing material;
an exit port defined within the body and providing a fluid exit path from the reservoir;
a fixed filter positioned across the exit port and in the fluid exit path; and,
a removable sorbent filter positioned within the reservoir and abutting the fixed filter.

9. The brewer of claim 8, wherein the removable sorbent filter is elongated and defines openings at each end.

10. The brewer of claim 9, wherein the removable sorbent filter comprises paper or cloth.

11. The brewer of claim 9, wherein the removable filter comprises paper, and the fixed filter comprises metal.

12. The brewer of claim 8, wherein the removable sorbent filter is cylindrically shaped and defining openings at each end.

13. The brewer of claim 12, wherein the removable sorbent filter comprises paper or cloth.

14. The brewer of claim 12, wherein the removable filter comprises paper, and the fixed filter comprises metal.

15. A method of brewing a beverage with a refillable beverage brewing cup, wherein the cup comprises:
a body defining a reservoir configured to receive and support brewing material, defining an opening, and defining a exit port defined within the body and providing a fluid exit path from the reservoir;
brewable material positioned in the reservoir;
a fixed filter positioned across the exit port and in the fluid exit path; and,
a removable sorbent filter positioned within the reservoir and abutting the fixed filter;
wherein the method comprises,
(a) Introducing heated liquid into the reservoir, which heated liquid forms a beverage after contact with the brewable material;
(b) Flowing the beverage through both the removable sorbent filter and the fixed filter, and out the exit port;

16. The method of claim 15, wherein the brewable material is coffee.

17. The method of claim 16, wherein the removable sorbent filter is elongated and defines openings at each end.

18. The method of claim 17, wherein the removable sorbent filter comprises paper or cloth.

19. The method of claim 17, wherein the removable filter comprises paper, and the fixed filter comprises metal.

20. The method of claim 16, wherein the removable sorbent filter is cylindrically shaped and defining openings at each end.

21. The method of claim 20, wherein the removable sorbent filter comprises paper or cloth.

22. The method of claim 20, wherein the removable filter comprises paper, and the fixed filter comprises metal.
